(19) United States
(12) Patent Application Publication
(10) Pub. No.: US 2012/0291514 A1
(43) Pub. Date: Nov. 22, 2012

(54) FORMING PUNCH ARRANGEMENT

(76) Inventor: Olle Strååt, Hestra (SE)

(21) Appl. No.: 13/574,242

(22) PCT Filed: Jan. 20, 2011
(86) PCT No.: PCT/SE11/00008

§ 371 Date: Jul. 19, 2012

(30) Foreign Application Priority Data
Feb. 11, 2010 (SE) 1050064-3

(51) Int. Cl. B25C 5/00

(52) U.S. Cl. 72/474

(57) ABSTRACT

Forming punch arrangement comprising a forming punch (1) and a forming block (18), wherein the forming punch bends elongated staple blanks (24) fed to the forming block over the forming block into a staple shape having a back part (30) and legs (31; 32) at an angle thereto, wherein the arrangement comprises at least a first forming punch (2) and a second forming punch (3) disposed one after the other, the first forming punch has a first leg forming part (4) and a second leg forming part (5), the second forming punch has a third leg forming part (11) and a fourth leg forming part (12), and the distance (d) between the leg forming parts (11; 12) in the region in which the parts bend the staple blank is less than the distance (D) between the leg forming parts (4; 5) on the first forming punch.

### TECHNICAL FIELD

This invention relates to a forming punch arrangement comprising a forming punch and a forming block, wherein the forming punch bends elongated staple blanks disposed on the forming block over the forming block into a staple shape having a back part and legs at an angle thereto.

### PRIOR ART

Forming punch arrangements of the type specified are generally known. They are common in staplers having a magazine in which elongated staple blanks are housed. Arrangements of this kind are also found in staple magazines having an integral forming punch and forming block and designed to be mounted on staplers. A magazine of this kind is described in International patent application WO2004/069486. International patent application WO93/20977 describes a staple magazine which includes a forming punch, but in which the forming block is mounted on the stapler. In all of these arrangements, the staple blank is fed after the forming operation to an outlet channel through which it is driven into a workpiece by means of a driver. However, in these previous arrangements, the angled legs of the bent blank spring back, thereby making feeding to the outlet channel more difficult or completely impossible. The springback is often intensified as a result of the fact that the back of the staple becomes slightly bow-shaped during the forming operation, which, together with the springback of the staple legs, makes it more difficult to drive the staple into the workpiece and thus may prevent satisfactory fixing. Various solutions have been adopted in order to overcome this disadvantage. One solution, as described in European patent EP 0 701 500, consists in that, during its backward movement, the back forming part included in the forming punch executes a return movement in which further pressure is applied to the back of the staple, as a result of which the back of the staple is straightened out slightly, thereby reducing springback. Another solution, as described in US patent U.S. Pat. No. 6,986,449, consists in that the back forming part of the forming punch is resiliently mounted relative to the leg forming parts of the forming punch. This solution means that the risk of the forming punch returning before the back forming part has pressed the back of the staple against the forming block, thereby creating a bow-shaped back, is completely eliminated. In addition, the solution means that the back forming part presses the staple against the forming block before the forming punch reaches its lowermost point so that the back of the staple simply has less of a bow shape. US patent U.S. Pat. No. 7,021,513 describes a solution which ensures that the bent staple is fed into the outlet channel with no problems, the solution including means for preventing the staple legs from springing back after the forming operation before the staple has been fed into the outlet channel.

### DISADVANTAGES OF THE PRIOR ART

However, all of the abovementioned solutions have disadvantages. The solution in which the forming punch executes a return movement in itself results in a slightly straighter staple back and reduced springback of the staple legs, but there is still undesired springback. In addition, the solution has a complicated construction and comprises a large number of parts, as a result of which it is expensive and difficult to manufacture and assemble. The solution in which the back forming part is resiliently mounted relative to the leg forming parts is in itself simple to manufacture and assemble, but only partly solves the problem of springback, as a result of which problems with springback and a bow-shaped back remain, although to a lesser extent. The solution in which means for preventing springback are included in itself solves the problem of feeding to the outlet channel, but the problem of a staple that can be difficult to drive into the workpiece remains.

In addition, in all of the previously known forming punch arrangements, the forming punch has to be moved so close to the forming block during its forming movement that the back of the staple is pressed against the forming block by the forming punch. This means that the forming movement has to be sharply defined at its lower turning point, as a result of which the parts involved must be tolerance-sensitive from the point of view of both manufacture and assembly.

There is therefore a need to provide a forming punch arrangement which ensures that the staple legs do not spring back in such a manner after the forming operation that feeding to an outlet channel is made more difficult, thereby forming a staple that can be driven into the workpiece without difficulty, and the forming movement of which can be undefined at its lower turning point.

### THE INVENTION

The invention now proposed provides a solution providing the desired properties with an arrangement of the type defined in the introductory part, characterised in that the arrangement comprises at least a first forming punch and a second forming punch disposed one after the other, the first forming punch has a first leg forming part and a second leg forming part, the second forming punch has a third leg forming part and a fourth leg forming part, and the distance between the leg forming parts in the region in which the parts bend the staple blank is less than the distance between the leg forming parts on the first forming punch.

The invention is further characterised in that the forming punch does not have a back forming part.

The invention is also characterised in that the first forming punch and the second forming punch are made in one piece.

The invention is also characterised in that the forming block has a width in the region of the forming part of the second forming punch which is less than the width in the region of the forming part of the first forming punch.

### BRIEF DESCRIPTION OF THE DRAWINGS

The invention will now be described with reference to the accompanying drawings, in which:

FIG. 1 is a straight back view of a forming punch forming part of this invention;

FIG. 2 is an oblique back view of the forming punch;

FIGS. 3-4 show two different embodiments of a forming block forming part of the invention;

FIGS. 5-9 show broken-away parts of a staple magazine including the forming punch arrangement according to this invention, a forming sequence being clear from the figures, and

FIGS. 10-16 are straight front views of details of the forming block and the forming punch forming part of the invention showing the sequence for the forming of a staple blank.

### EMBODIMENT

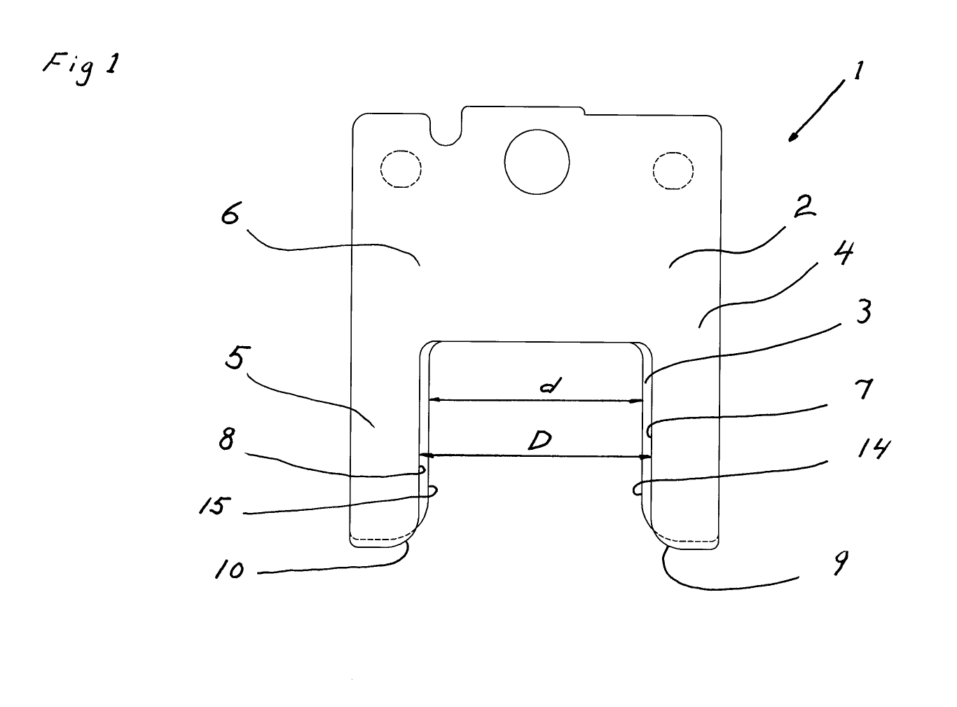

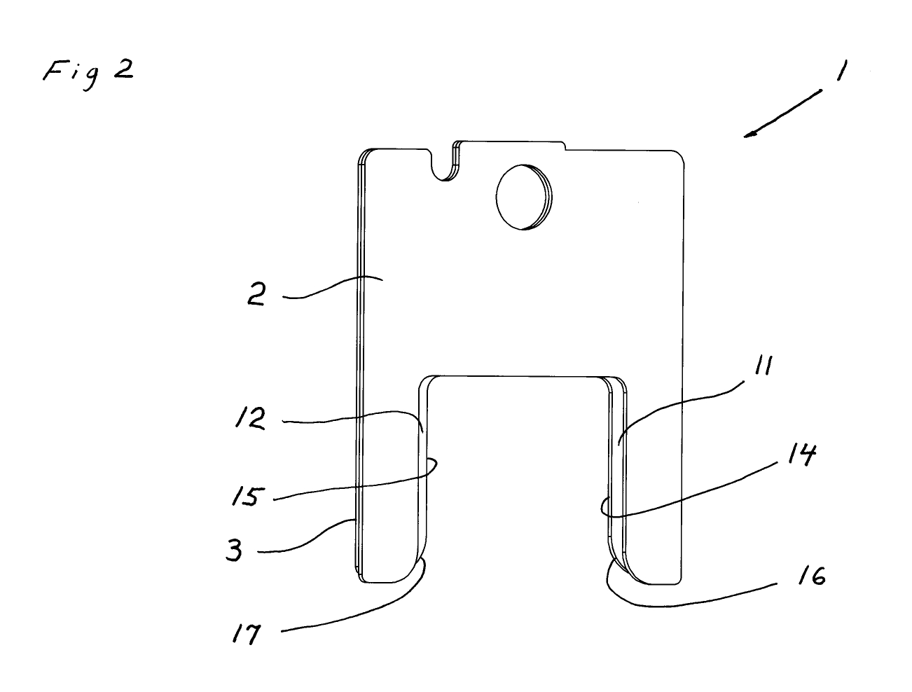

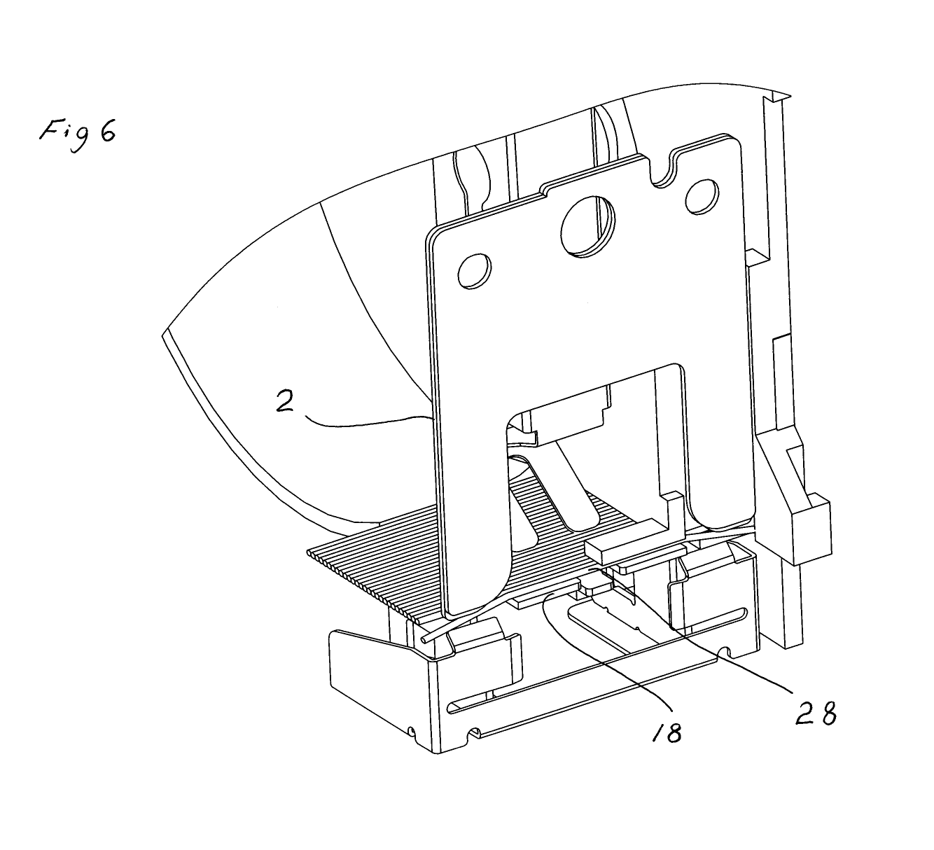

FIGS. 1-2 show a forming punch 1 forming part of the invention, comprising a first forming punch 2 and a second forming punch 3. The forming punch 2 has a first leg forming part 4 and a second leg forming part 5. The parts 4 and 5 are connected to an intermediate connecting plate 6 the function of which is simply to connect the parts 4 and 5 so as to allow for simple and synchronous operation of these parts. The parts 4 and 5 do not necessarily have to be connected to one another and it is sufficient for the parts to move synchronously during their forming movement. The part 4 has a first forming edge 7 and the part 5 has a second forming edge 8. The edge 7 is bow-shaped 9 in is lowermost region and the edge 8 is bow-shaped 10. The forming punch 3 has a third leg forming part 11 and a fourth leg forming part 12. These parts 11 and 12 are connected in the same manner as the parts 4 and 5 to an intermediate connecting plate 13 (FIG. 5). This connecting plate has the same function as the connecting plate 6 and the same thing applies to the parts 11 and 12 as to the parts 4 and 5 in that it is sufficient for the parts to move synchronously during their forming movement. The part 11 has a third forming edge 14 and the part 12 has a fourth forming edge 15. The edge 14 is bow-shaped 16 in its lowermost part and the edge 15 is bow-shaped 17.

It will be clear from FIG. 1 that the distance d between the edges 14 and 15 is less than the corresponding distance D between the edges 7 and 8. The figures show the first forming punch 2 and the second forming punch 3 manufactured as separate parts and placed together to form one unit. However, it is irrelevant to the function of the invention whether the punches 2 and 3 are disposed at a distance from one another or whether the punches are made in one piece and thus form one integral unit.

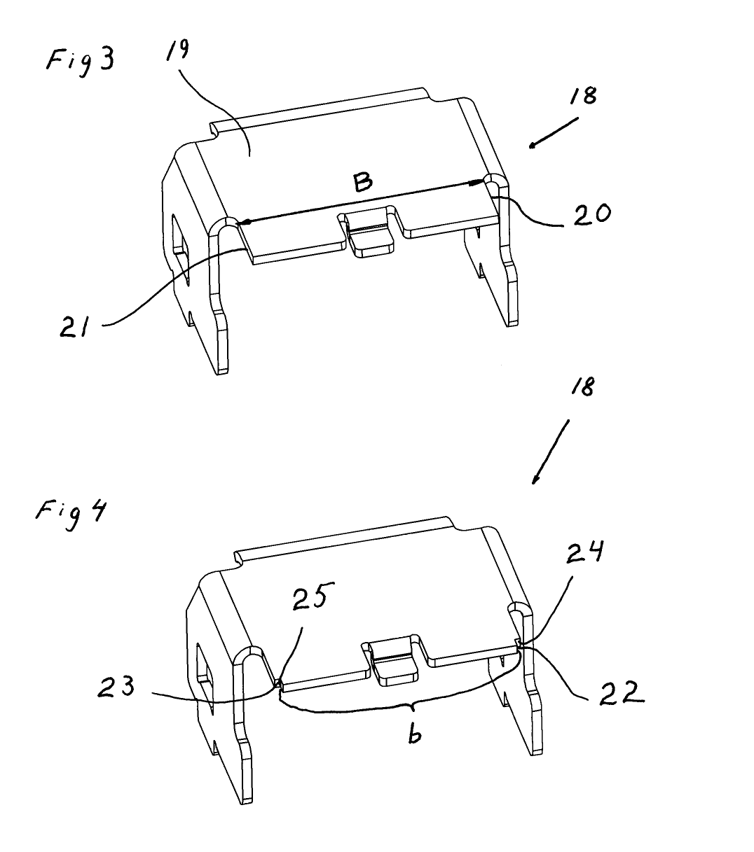

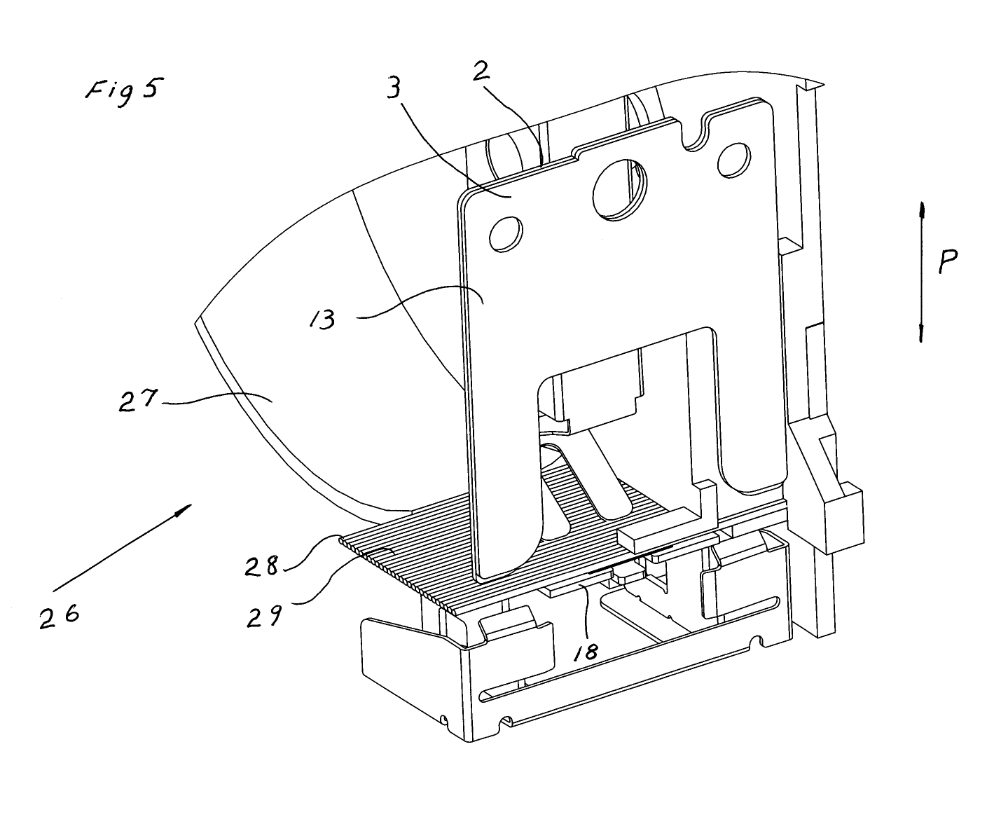

FIG. 3 shows one embodiment of the forming block 18 forming part of the invention. The forming block has an upper surface 19 to which the staple blanks to be bent are applied and which will be described hereinbelow. The forming block also has edges 20 and 21 around which the staple blank is bent in a manner that will also be described hereinbelow. The width of the forming block and thus the distance between the edges 20 and 21 is designated B. FIG. 4 shows an alternative forming block provided on its front edge with recesses 22 and 23. These recesses have a thickness a in the longitudinal direction L of the forming block which at least corresponds to the thickness of the staple blank to be bent. The recess 22 has the edge 24 and the recess 23 has the edge 25. The distance between the edges 24 and 25 is designated b. It will be clear from the rest of the description that, in order to carry out the invention using the forming block of FIG. 3, the distance d must be at least B plus the thickness of the bent staple blank times two. When a forming block of the type shown in FIG. 4 is used, the distance d must be at least b plus the thickness of the bent staple blank times two and D must be at least B plus the thickness of the bent staple blank times two.

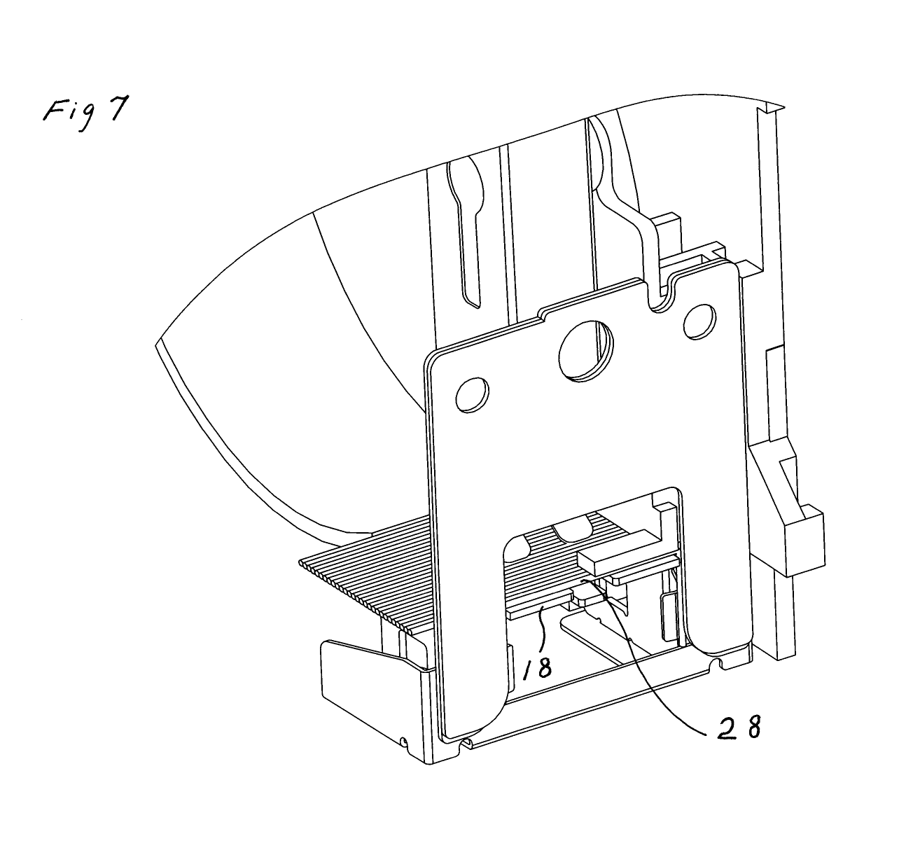

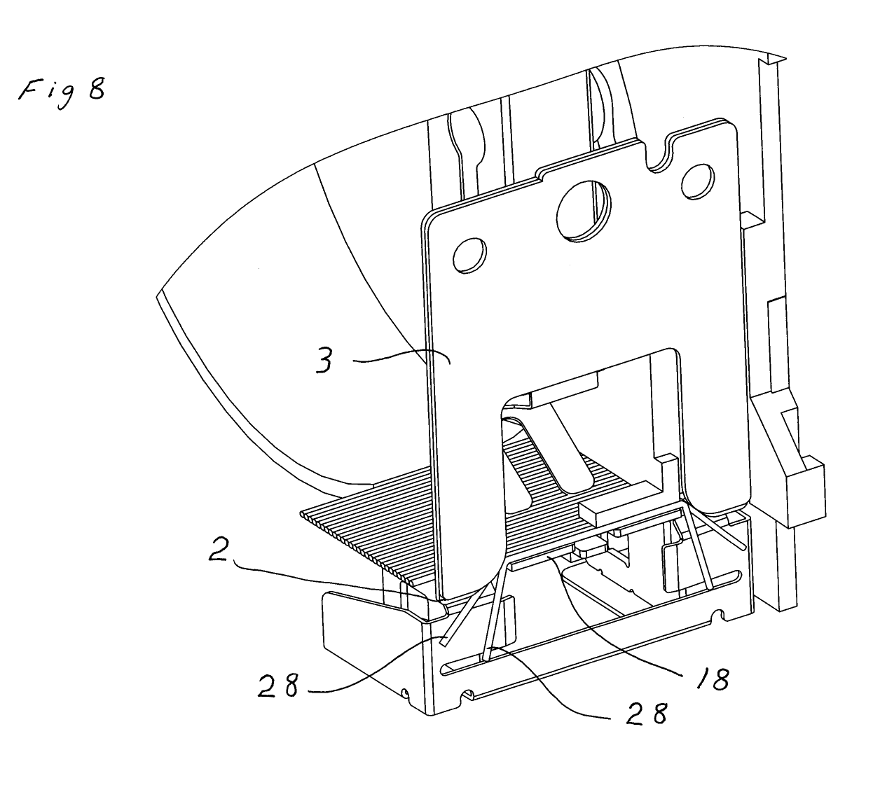

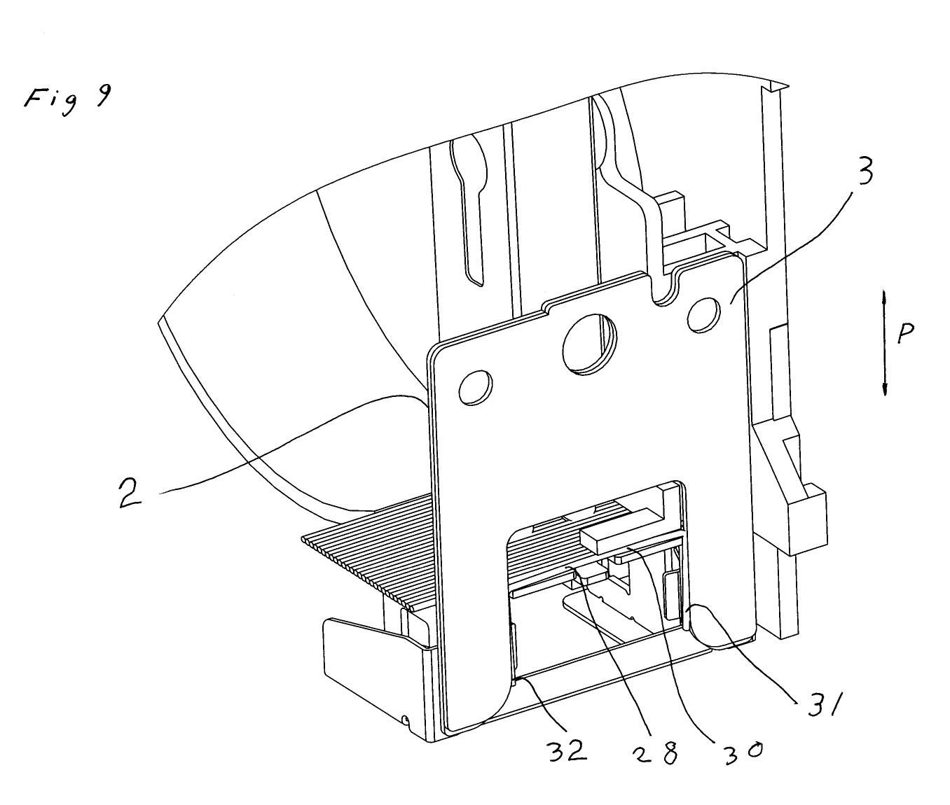

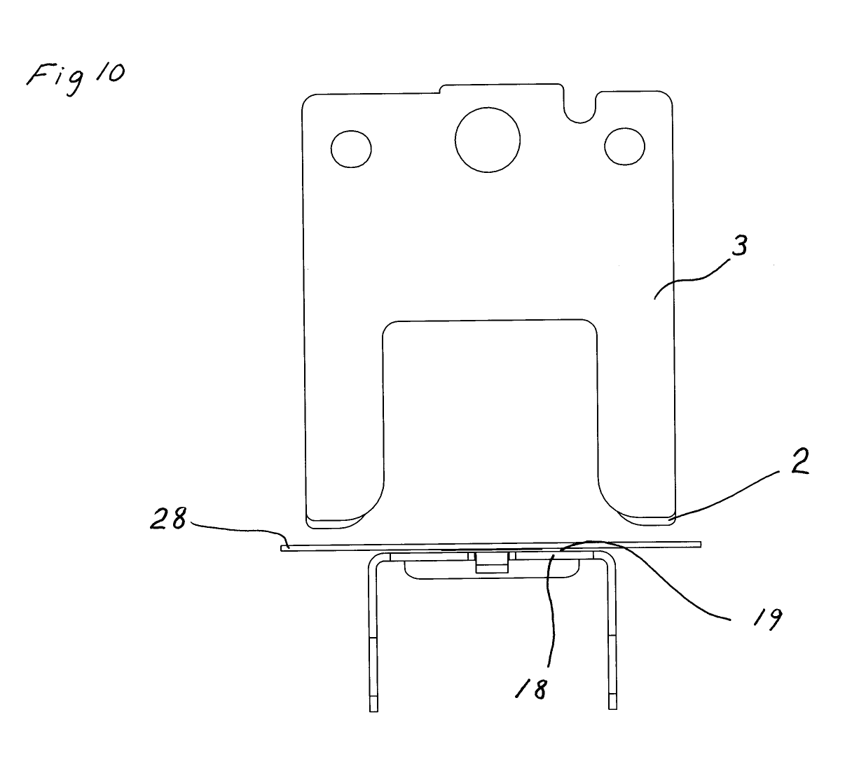

FIGS. 5-9 show a forming punch arrangement according to this invention in diagrammatic form mounted on a staple magazine 26. The staple magazine is shown in very diagrammatic form and only those parts required for an understanding of the invention are shown. The staple magazine is preferably mounted on a stapler not shown in the figures. The staple magazine comprises a container 27 in which elongated staple blanks 28 are housed. The blanks are connected via their longitudinal sides in order to form a staple strip 29. The staple strip is housed in the form of a reel (not shown in the figures) in the container 27 only partly shown in the figures. The staple strip is fed forwards by a feed device not shown in the figures, but obvious to the person skilled in the art. The feed device may be accommodated in the staple magazine or in the stapler on which the magazine is mounted. A forming punch arrangement according to this invention comprising a forming block 18 and forming punches 2 and 3 is mounted on the staple magazine. The forming punches are driven by a drive arrangement not shown in the figures, but obvious to the person skilled in the art, in an upward and downward motion indicated by the double arrow P, this movement also being obvious to the person skilled in the art. In FIG. 5, a staple blank 28 is fed by the feed device (not shown) to the region in which the first forming punch 2 bends the staple blank over the forming block 18. In FIG. 6, the forming movement has begun and the drive device has moved the forming punches downwards towards the staple blank 28 partly formed into a staple shape. In FIG. 7, the forming punches have been driven into their lower position by the drive device and the staple blank 28 has undergone a first forming operation. In FIG. 8, the forming punches have returned from their lowermost position and the staple strip has been fed forwards by the feed arrangement so that the foremost staple blank in the staple strip arrives in the region of the working range of the second forming punch. The forming punches have begun a new forming movement and, in this position, the first forming punch 2 has begun a first forming movement on a staple blank at the same time as the second forming punch 3 has begun a second forming operation on the staple blank 28 that has already undergone a first forming movement. In FIG. 9, the forming punches 2 and 3 are situated in their lowermost positions and, in this position, a foremost staple blank 28 has undergone a first and a second forming movement. After this forming movement, the staple blank has been bent into a staple shape with a back part 30 and staple legs 31 and 32 angled thereto. As will be clear from the figures, no part of the forming punches 2 and 3 is in contact with the part of the staple blank resting on the forming block 18 and forming the back 30 of the staple. This offers the advantage that the forming punches do not have to be provided with a back forming part. In addition, the invention offers the advantage that the forming movement P does not have to be sharply defined at its lower turning point.

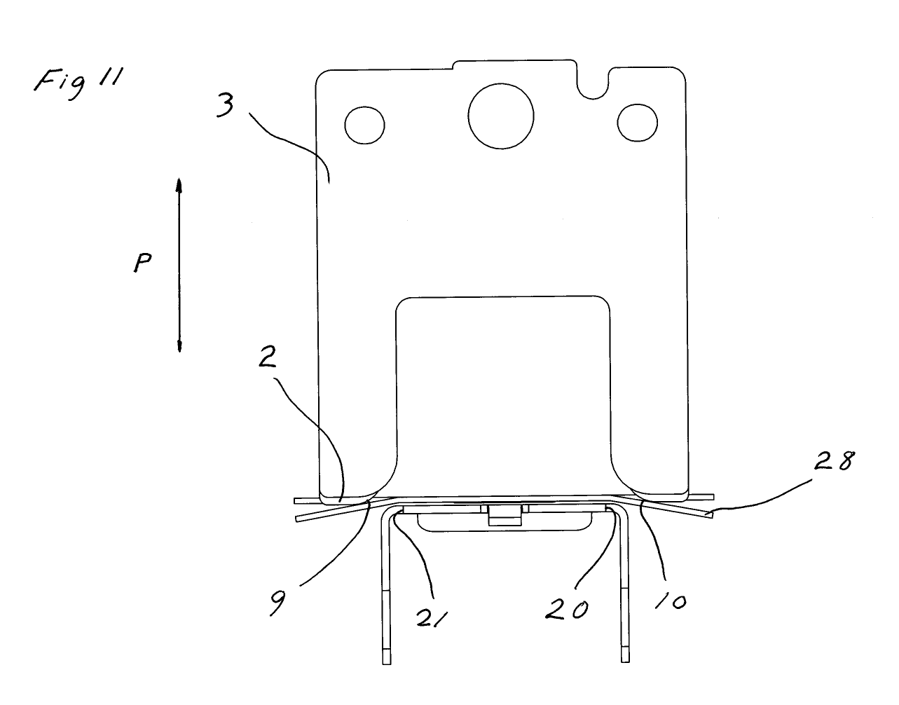

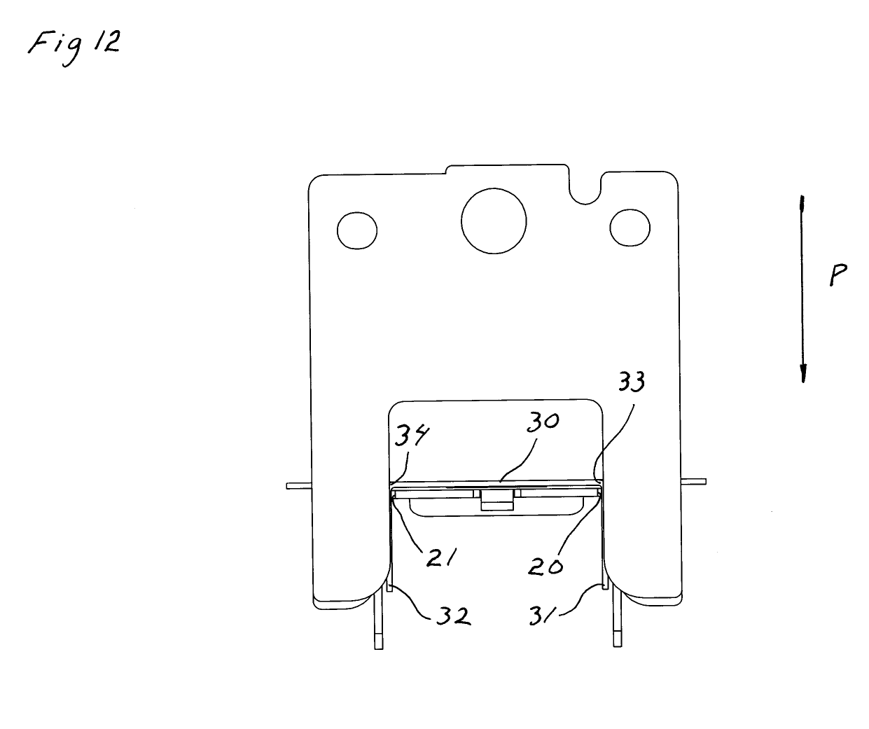

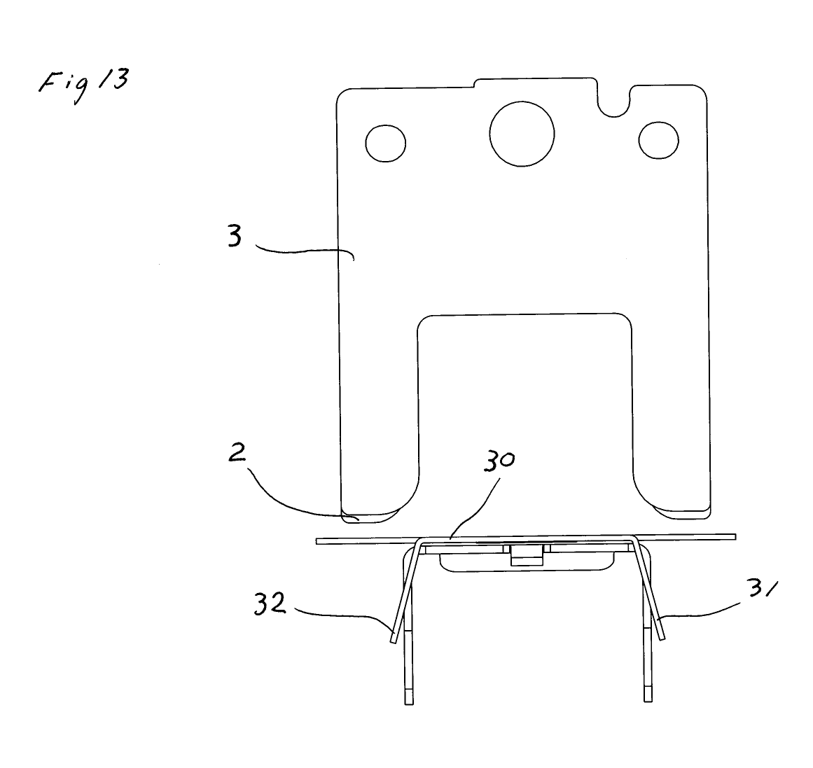

A forming punch arrangement according to this invention comprising a forming punch and a forming block will now be described in detail in the course of one complete forming sequence with reference to FIGS. 10-16. In FIG. 10, the forming punches 2 and 3 are situated in a starting position. A staple blank 28 is disposed on the upper surface 19 of the forming block 18. In FIG. 11, the forming punches 2 and 3 have been driven downwards during the forming movement P into a position in which the bow-shaped edge parts 9 and 10 meet the staple blank 28 and the bending of the blank 28 around the edges 20 and 21 begins. In FIG. 12, the forming punches have reached their lowermost positions and the staple blank 28 has been formed by means of the edges 7 and 8 hidden in the figure into a staple with a back part 30 which, via first and second bends 33 and 34 around the edges 20 and 21, passes over into the legs 31 and 32 at an angle to the back part.

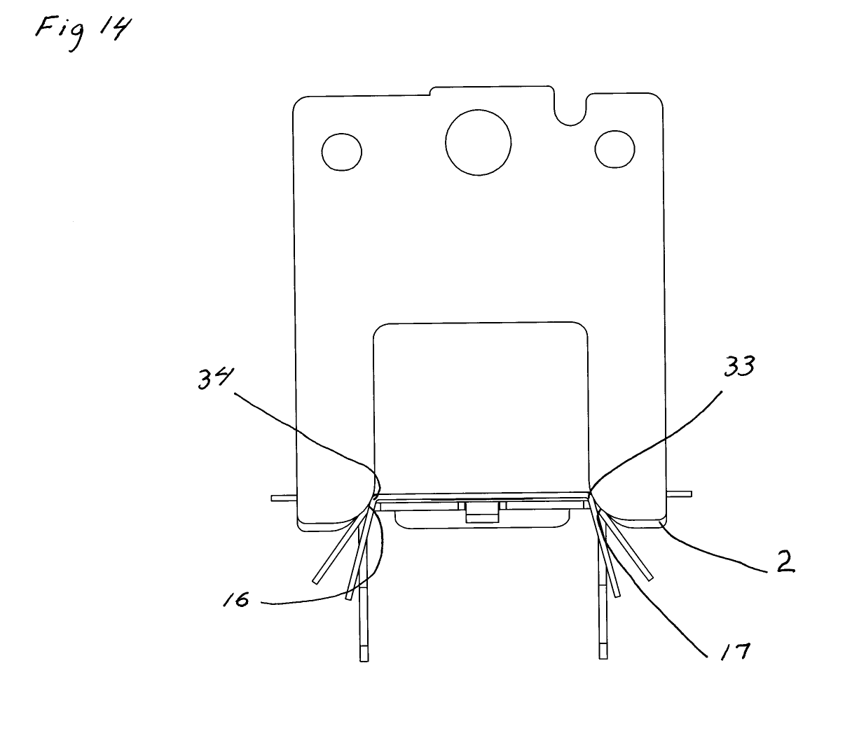

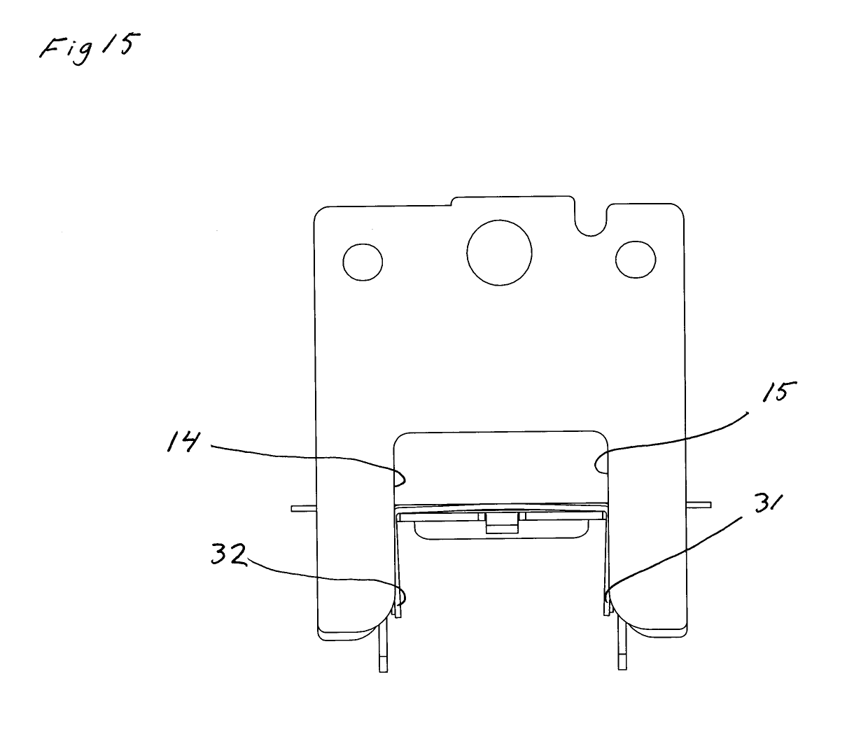

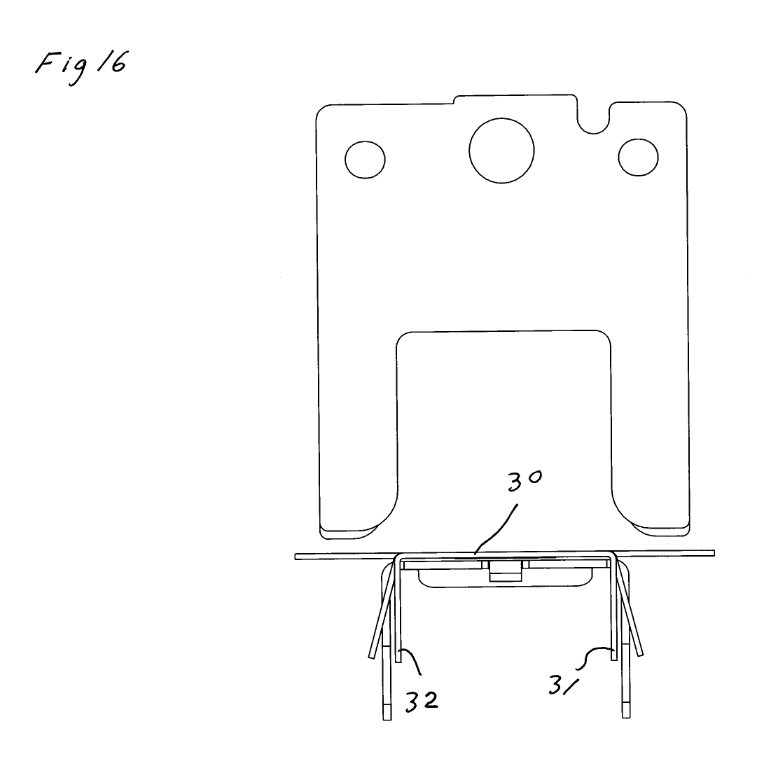

This forming operation is not shown clearly in the figure, but is obvious to the person skilled in the art. In FIG. 13, the forming punches have returned to the starting position and thus, as will be clear, the legs 31 and 32 have sprung back relative to the back part 30. In this position, the staple strip is fed forwards, this not being shown in the figures but being obvious to the person skilled in the art. As a result of the feeding operation, the staple blank formed into a staple shape arrives in the region of the working range of the second forming punch 3. At the same time, a new staple blank arrives in the working range of the first forming punch 2. In FIG. 14, the forming punches have been driven from the starting position into a position in which the first forming punch 2 bends a second staple blank in the manner described previously at the same time as the second forming punch with the bow-shaped forming edges 16 and 17 meets the staple blank formed into a staple shape at the bends 33 and 34, as a result of which the forming in this second forming operation takes place on an already bent part of the staple blank. In FIG. 15, the forming punches have been driven to their lowermost point, the foremost staple has been bent by the edges 14 and 15 and the staple has achieved its final shape. In FIG. 16, the forming punches have returned to the starting position and, as will be clear, there is no springback of the staple legs 31, 32 relative to the back 30 of the staple. This effect is achieved as a result of the fact that the second forming punch bends the staple at the already formed bends 33 and 34, achieved as a result of the fact that the distance d from the second forming punch is less than the distance D from the first forming punch. In the figures, the forming operation has taken place over a forming block of the type shown in FIG. 3. A forming block of the type shown in FIG. 4 can be used in order to further increase the bending in the second forming operation and therefore to further reduce springback. With a forming block of this kind, the second forming operation takes place over a forming block which is narrower than the forming block over which the first bending operation takes place. It will thus be clear to the person skilled in the art that the bending at the bends 33 and 34 is increased slightly relative to a supported staple back without any support at the outer edges of the staple back, thereby resulting in further reduced springback of the staple legs.

1. A forming device comprising a forming punch arrangement and a forming block, wherein the forming punch arrangement bends elongated staple blanks fed to the forming block over the forming block into a staple shape having a back part and legs at an angle thereto,
CHARACTERISED IN THAT the forming punch arrangement comprises at least a first forming punch portion and a second forming punch portion disposed one after the other and each bending the fed staple blank, in that the first forming punch portion has a first leg forming part and a second leg forming part, in that the second forming punch portion has a third leg forming part and a fourth leg forming part, and in that a distance (d) between the leg forming parts of the second forming punch portion in a region in which the those parts bend the staple blank is less than a corresponding distance (D) between the leg forming parts of the first forming punch portion.

2. The forming device according to claim 1, CHARACTERISED IN THAT the forming punch arrangement does not have a back forming part.

3. The forming device according to claim 1, CHARACTERISED IN THAT the first forming punch portion and the second forming punch portion are made in one piece.

4. The forming device according to claim 1, CHARACTERISED IN THAT the forming block has a width (b) in a region of the leg forming parts of the second forming punch portion which is less than a width (B) thereof in a region of the leg forming parts of the first forming punch portion.

5. The forming device according to claim 2, CHARACTERISED IN THAT the first forming punch portion and the second forming punch portion are made in one piece.

6. The forming device according to claim 2, CHARACTERISED IN THAT the forming block has a width (b) in a region of the leg forming parts of the second forming punch portion which is less than a width (B) thereof in a region of the leg forming parts of the first forming punch portion.

7. The forming device according to claim 3, CHARACTERISED IN THAT the forming block has a width (b) in a region of the leg forming parts of the second forming punch portion which is less than a width (B) thereof in a region of the leg forming parts of the first forming punch portion.

8. Forming punch arrangement according to claim 5, CHARACTERISED IN THAT the forming block has a width (b) in a region of the leg forming parts of the second forming punch portion which is less than a width (B) thereof in a region of the leg forming parts of the first forming punch portion.
